(19) United States
(12) Patent Application Publication
(10) Pub. No.: US 2020/0223087 A1
(43) Pub. Date: Jul. 16, 2020

(54) Pizza Slicing Device

(71) Applicant: Carl Giangregorio, Westlake Village, CA (US)

(72) Inventor: Carl Giangregorio, Westlake Village, CA (US)

(21) Appl. No.: 16/249,491

(22) Filed: Jan. 16, 2019

(51) Int. Cl. B26D 3/24; B26D 1/04; B26D 5/08

(52) U.S. Cl. CPC B26D 3/24; B26D 2210/02; B26D 5/086; B26D 1/04

(57) ABSTRACT

A pizza slicing device for automated pizza cutting includes a housing that defines an interior space. The housing is coupled to and extends vertically from a first end of a base plate. A bar, which is tubular, is coupled to the housing distal from the base plate. The bar extends perpendicularly from the housing toward a second end of the base plate. A cutting assembly is coupled to and is selectively extendable from a bottom of the bar. An actuator is coupled to the housing and positioned in the interior space. The actuator is operationally coupled to the cutting assembly. The actuator is positioned to urge the cutting assembly to extend from the bar. The cutting assembly extends to the base plate so that a pizza that is positioned on the base plate is sliced.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art including information disclosed under 37 CFR 1.97 and 1.98

The disclosure and prior art relates to slicing devices and more particularly pertains to a new slicing device for automated pizza cutting.

### (h) BRIEF SUMMARY OF THE INVENTION

An embodiment of the disclosure meets the needs presented above by generally comprising a housing that defines an interior space. The housing is coupled to and extends vertically from a first end of a base plate. A bar, which is tubular, is coupled to the housing distal from the base plate. The bar extends perpendicularly from the housing toward a second end of the base plate. A cutting assembly is coupled to and is selectively extendable from a bottom of the bar. An actuator is coupled to the housing and positioned in the interior space. The actuator is operationally coupled to the cutting assembly. The actuator is positioned to urge the cutting assembly to extend from the bar. The cutting assembly extends to the base plate so that a pizza that is positioned on the base plate is sliced.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a pizza slicing device according to an embodiment of the disclosure.

FIG. 2 is a side view of an embodiment of the disclosure.

FIG. 3 is a cross-sectional view of an embodiment of the disclosure.

FIG. 4 is an exploded view of an embodiment of the disclosure.

### (j) DETAILED DESCRIPTION OF THE INVENTION

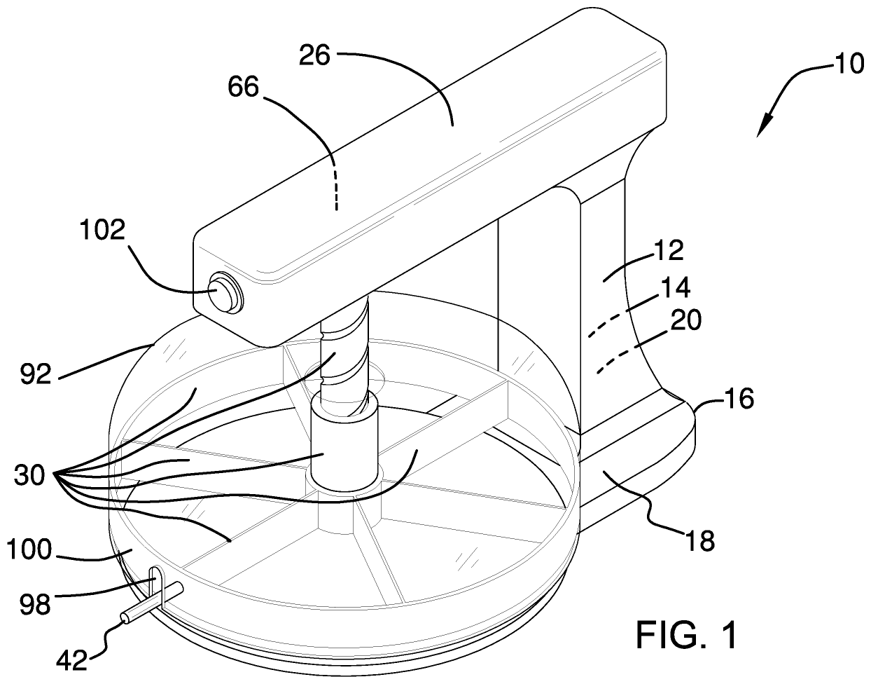

With reference now to the drawings, and in particular to FIGS. 1 through 4 thereof, a new slicing device embodying the principles and concepts of an embodiment of the disclosure and generally designated by the reference numeral 10 will be described.

As best illustrated in FIGS. 1 through 4, the pizza slicing device 10 generally comprises a housing 12 that defines an interior space 14. The housing 12 is coupled to and extends vertically from a first end 16 of a base plate 18. A power module 20 is coupled to the housing 12 and positioned in the interior space 14. The power module 20 comprises a power cord 22. A plug 24 of the power cord 22 is configured to couple the power cord 22 to a source of electrical current.

A bar 26, which is tubular, is coupled to the housing 12 distal from the base plate 18. The bar 26 extends perpendicularly from the housing 12 toward a second end 28 of the base plate 18. A cutting assembly 30 is coupled to and is selectively extendable from a bottom 32 of the bar 26.

The cutting assembly 30 comprises an inner ring 34, an outer ring 36, and a plurality of blades 38. A handle 42 is coupled to and extends radially from the outer ring 36. Each blade 38 is coupled to and extends between the inner ring 34 and the outer ring 36. The blades 38 are evenly spaced on an outer circumference 40 of the inner ring 34. As will become apparent, the even spacing of the blades 38 is designed to provide equally sized slices of a pizza. The plurality of blades 38 comprises from four to ten blades 38. The plurality of blades 38 comprises six blades 38.

A tube 44 is positioned in and is coupled to the inner ring 34. The tube 44 extends from a top 46 of the inner ring 34. An extrusion 48 is coupled to and extends from an inner surface 50 of the tube 44. The extrusion 48 extends spirally around the tube 44 from a lower endpoint 52 to an upper endpoint 54 of the tube 44.

A first rod 56 positioned in the tube 44. A channel 58 extends into an outer surface 60 of the first rod 56. The channel 58 is complementary to the extrusion 48 so that the first rod 56 is gearedly coupled to the tube 44. A second rod 62 extends axially from an upper end 64 of the first rod 56 into the bar 26. The second rod 62 is circumferentially smaller than the first rod 56.

An actuator 66 is coupled to the housing 12 and is positioned in the interior space 14. The actuator 66 is operationally coupled to the cutting assembly 30 and is positioned to urge the cutting assembly 30 to extend from the bar 26. The cutting assembly 30 extends to the base plate 18 so that a pizza that is positioned on the base plate 18 is sliced.

The actuator 66 comprises a microprocessor 68 and motor 70 that are coupled to the housing 12 and positioned in the interior space 14. The microprocessor 68 is operationally coupled to the power module 20. The motor 70 is operationally coupled to the microprocessor 68. A shaft 72 of the motor 70 extends into the bar 26.

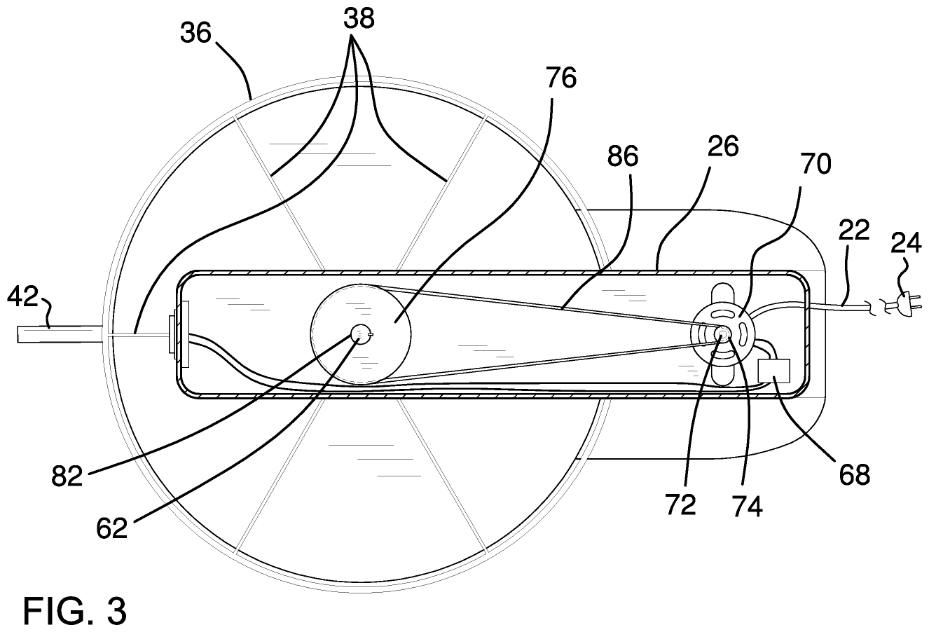

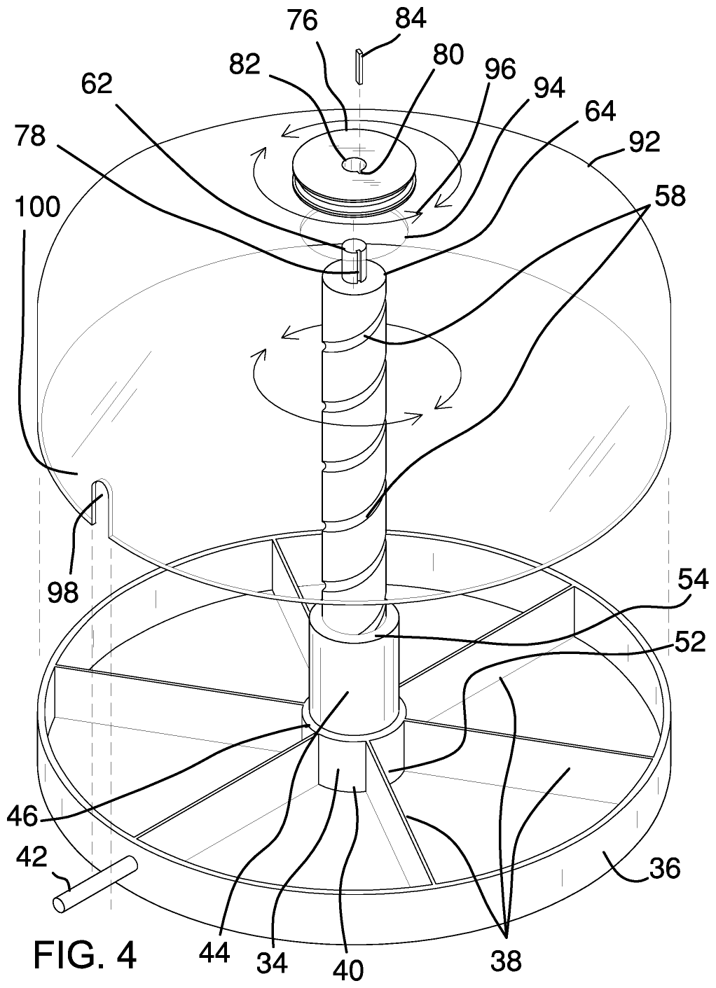

A first pulley 74 is coupled to the shaft 72, as shown in FIG. 3. A second pulley 76 is coupled to the second rod 62. A first slot 78 extends into the second rod 62. A second slot 80 extends into an inner perimeter 82 of the second pulley 76 so that the second slot 80 is alignable with the first slot 78. A key 84 selectively insertable into the first slot 78 and the second slot 80 to couple the second pulley 76 to the second rod 62, as shown in FIG. 4.

A belt 86 positioned around the first pulley 74 and the second pulley 76. The microprocessor 68 is positioned to actuate the motor 70 to rotate the shaft 72 so that rotation is transferred through the first pulley 74, the belt 86, and the second pulley 76 to the first rod 56. The handle 42 is configured to be grasped in a hand of a user to prevent rotation of the cutting assembly 30. The tube 44 is urged distally from the bar 26, positioning the plurality of blades 38 to slice the pizza that is positioned on the base plate 18.

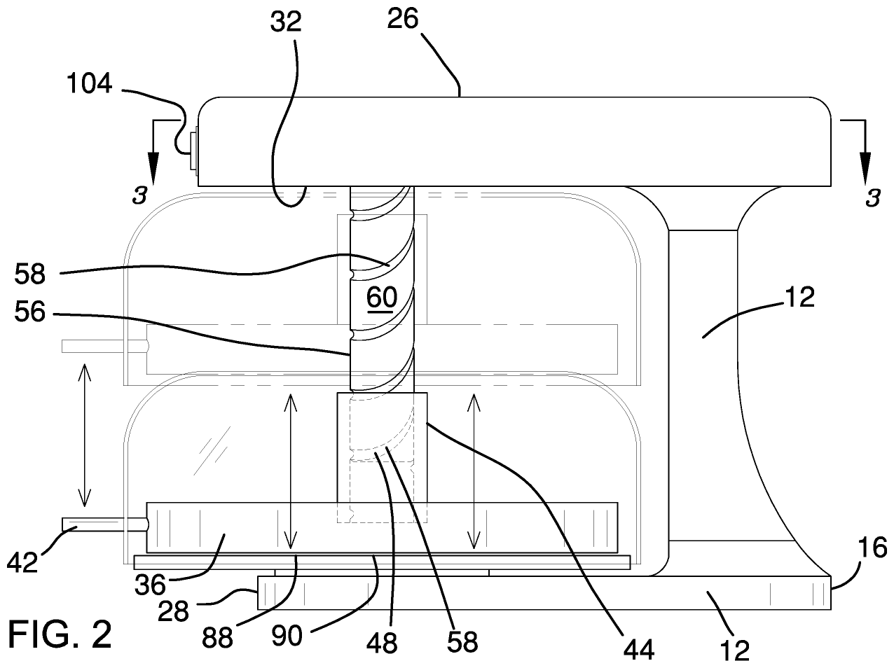

A disc 88 is coupled to the base plate 18 so that a center 90 of the disc 88 is axially aligned with the first rod 56, as shown in FIG. 2. The disc 88 is configured to position the pizza. A shell 92, which is dome shaped and open-bottomed, is configured to cover the pizza that is positioned on the base plate 18. An opening 94 is centrally positioned in an upper limit 96 of the shell 92. The first rod 56 is positioned through the opening 94. A cutout 98 is positioned in a side 100 of the shell 92 and is positioned to insert the handle 42 as the cutting assembly 30 is extended from the bar 26 to the base plate 18, as shown in FIG. 1.

A controller 102 is coupled to the bar 26 distal from the housing 12, as shown in FIG. 3. The controller 102 is operationally coupled to the microprocessor 68. The controller 102 is positioned to selectively signal the microprocessor 68 to actuate the actuator 66 to urge the cutting assembly 30 to extend from the bar 26 so that the cutting assembly 30 extends to the base plate 18 to slice the pizza that is positioned on the base plate 18.

The controller 102 comprises a button 104 that is depressible. The button 104 is configured to be depressed a first time to signal the microprocessor 68 to extend the cutting assembly 30 and to be depressed a second time to raise the cutting assembly 30.

In use, the pizza is placed on the disc 88 and the shell 92 is positioned over the pizza with the handle 42 positioned in the cutout 98. The user grasps the handle 42 to prevent rotation of the cutting assembly 30. The button 104 is depressed the first time to signal the microprocessor 68 to extend the cutting assembly 30 to slice the pizza. The button 104 is depressed the second time to raise the cutting assembly 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. (canceled)

2. A pizza slicing device comprising:
a base plate;
a housing coupled to and extending vertically from a first end of the base plate, the housing defining an interior space;
a bar coupled to the housing distal from the base plate, the bar extending perpendicularly from the housing toward a second end of the base plate, the bar being tubular;
a cutting assembly coupled to and selectively extendable from a bottom of the bar;
an actuator coupled to the housing and positioned in the interior space, the actuator being operationally coupled to the cutting assembly wherein the actuator is positioned for urging the cutting assembly for extending from the bar such that the cutting assembly extends to the base plate such that a pizza positioned on the base plate is sliced;
a power module coupled to the housing and positioned in the interior space;
the cutting assembly comprising:
an inner ring,
an outer ring,
a handle coupled to and extending radially from the outer ring,
a plurality of blades, each blade being coupled to and extending between the inner ring and the outer ring, the blades being evenly spaced on an outer circumference of the inner ring,
a tube positioned in and coupled to the inner ring, the tube extending from a top of the inner ring,
an extrusion coupled to and extending from an inner surface of the tube, the extrusion extending spirally around the tube from a lower endpoint to an upper endpoint of the tube,
a first rod positioned in the tube,
a channel extending into an outer surface of the first rod, the channel being complementary to the extrusion such that the first rod is gearedly coupled to the tube, and
a second rod extending axially from an upper end of the first rod into the bar, the second rod being circumferentially smaller than the first rod; and
the actuator comprising:
a microprocessor coupled to the housing and positioned in the interior space, the microprocessor being operationally coupled to the power module,
a motor coupled to the housing and positioned in the interior space such that a shaft of the motor extends into the bar, the motor being operationally coupled to the microprocessor,
a first pulley coupled to the shaft,
a second pulley coupled to the second rod, and
a belt positioned around the first pulley and the second pulley wherein the microprocessor is positioned for actuating the motor for rotating the shaft such that rotation is transferred through the first pulley, the belt, and the second pulley to the first rod, and wherein the handle is configured for grasping in a hand of a user for preventing rotation of the cutting assembly wherein the tube is urged distally from the bar positioning the plurality of blades to slice the pizza positioned on the base plate.

3. The device of claim 2, further including the power module comprising a power cord wherein a plug of the power cord is configured for coupling the power cord to a source of electrical current.

4. The device of claim 2, further including the plurality of blades comprising from four to ten blades.

5. The device of claim 4, further including the plurality of blades comprising six blades.

6. The device of claim 2, further comprising:
a first slot extending into the second rod;
a second slot extending into an inner perimeter of the second pulley such that the second slot is alignable with the first slot; and
a key selectively insertable into the first slot and the second slot for coupling the second pulley to the second rod.

7. The device of claim 2, further including a disc coupled to the base plate such that a center of the disc is axially aligned with the first rod wherein the disc is configured for positioning the pizza.

8. The device of claim 2, further comprising:
a shell, the shell being dome shaped, the shell being open-bottomed such that the shell is configured for covering the pizza positioned on the base plate;
an opening centrally positioned in an upper limit of the shell, the first rod being positioned through the opening; and
a cutout positioned in a side of the shell wherein the cutout is positioned for inserting the handle as the cutting assembly is extended from the bar to the base plate.

9. The device of claim 2, further including a controller coupled to the bar distal from the housing, the controller being operationally coupled to the microprocessor wherein the controller is positioned for selectively signaling the microprocessor for actuating the actuator for urging the cutting assembly for extending from the bar such that the cutting assembly extends to the base plate such that the pizza positioned on the base plate is sliced.

10. The device of claim 9, further including the controller comprising a button, the button being depressible wherein the button is configured for depressing a first time for signaling the microprocessor for extending the cutting assembly and for depressing a second time for raising the cutting assembly.

11. A pizza slicing device comprising:
a base plate;
a housing coupled to and extending vertically from a first end of the base plate, the housing defining an interior space;
a power module coupled to the housing and positioned in the interior space, the power module comprising a power cord wherein a plug of the power cord is configured for coupling the power cord to a source of electrical current;
a bar coupled to the housing distal from the base plate, the bar extending perpendicularly from the housing toward a second end of the base plate, the bar being tubular;
a cutting assembly coupled to and selectively extendable from a bottom of the bar, the cutting assembly comprising:
an inner ring,
an outer ring,
a handle coupled to and extending radially from the outer ring,
a plurality of blades, each blade being coupled to and extending between the inner ring and the outer ring, the blades being evenly spaced on an outer circumference of the inner ring, the plurality of blades comprising from four to ten blades, the plurality of blades comprising six blades,
a tube positioned in and coupled to the inner ring, the tube extending from a top of the inner ring,
an extrusion coupled to and extending from an inner surface of the tube, the extrusion extending spirally around the tube from a lower endpoint to an upper endpoint of the tube,
a first rod positioned in the tube,
a channel extending into an outer surface of the first rod, the channel being complementary to the extrusion such that the first rod is gearedly coupled to the tube,
a second rod extending axially from an upper end of the first rod into the bar, the second rod being circumferentially smaller than the first rod, and
a first slot extending into the second rod;
an actuator coupled to the housing and positioned in the interior space, the actuator being operationally coupled to the cutting assembly wherein the actuator is positioned for urging the cutting assembly for extending from the bar such that the cutting assembly extends to the base plate such that a pizza positioned on the base plate is sliced, the actuator comprising:
a microprocessor coupled to the housing and positioned in the interior space, the microprocessor being operationally coupled to the power module,
a motor coupled to the housing and positioned in the interior space such that a shaft of the motor extends into the bar, the motor being operationally coupled to the microprocessor,
a first pulley coupled to the shaft,
a second pulley coupled to the second rod,
a second slot extending into an inner perimeter of the second pulley such that the second slot is alignable with the first slot,
a key selectively insertable into the first slot and the second slot for coupling the second pulley to the second rod, and
a belt positioned around the first pulley and the second pulley wherein the microprocessor is positioned for actuating the motor for rotating the shaft such that rotation is transferred through the first pulley, the belt, and the second pulley to the first rod, and wherein the handle is configured for grasping in a hand of a user for preventing rotation of the cutting assembly wherein the tube is urged distally from the bar positioning the plurality of blades to slice the pizza positioned on the base plate;
a disc coupled to the base plate such that a center of the disc is axially aligned with the first rod wherein the disc is configured for positioning the pizza;
a shell, the shell being dome shaped, the shell being open-bottomed such that the shell is configured for covering the pizza positioned on the base plate;
an opening centrally positioned in an upper limit of the shell, the first rod being positioned through the opening;
a cutout positioned in a side of the shell wherein the cutout is positioned for inserting the handle as the cutting assembly is extended from the bar to the base plate; and
a controller coupled to the bar distal from the housing, the controller being operationally coupled to the microprocessor wherein the controller is positioned for selectively signaling the microprocessor for actuating the actuator for urging the cutting assembly for extending from the bar such that the cutting assembly extends to the base plate such that the pizza positioned on the base plate is sliced, the controller comprising a button, the button being depressible wherein the button is configured for depressing a first time for signaling the microprocessor for extending the cutting assembly and for depressing a second time for raising the cutting assembly.
